(19) United States
(12) Patent Application Publication
(10) Pub. No.: US 2011/0096145 A1
(43) Pub. Date: Apr. 28, 2011

(54) Method and Device for Rendering and Generating Computer-Generated Video Holograms

(75) Inventor: Alexander Schwerdtner, Dresden (DE)

(73) Assignee: See Real Technologies S.A., lu (LU)

(21) Appl. No.: 12/301,775

(22) PCT Filed: May 23, 2007
(86) PCT No.: PCT/EP2007/054989

§ 371 Date: Dec. 3, 2010

(30) Foreign Application Priority Data
May 23, 2006 (DE) 102006025096.6

(51) Int. Cl. H04N 5/89

(52) U.S. Cl. 348/40; 348/E13.001

(57) ABSTRACT

Method for real-time rendering and generation of computer-generated video holograms from image data with depth information, where in a first mode a 3D rendering graphics pipeline (3DPL) describes the conversion of a scene into pixelated image data in the form of a two-dimensional projection of the scene and which generates pixel values for the controllable pixels of a monitor. The pipeline is switchably extended such that in a second mode in at least one holographic graphics pipeline (HPL) complex hologram values are generated and a light modulator means (SLM) of a holographic display device (HAE) is encoded with these pixel values, whereby simultaneously or alternatively to the usual graphic representation an incident wave field is modulated by way of controlling the light modulator means (SLM) such that the desired scene is reconstructed through interference in space.

### FIELD OF THE INVENTION

The invention relates to a method and a device for real-time rendering and generating of computer-generated video holograms CGVH from image data with depth information. As regards the rendering process, the invention relates to the 3D rendering pipeline, which describes the algorithms from the vectorial, mathematical description of a scene to the pixelated image on the monitor screen. The image data comprise depth information and usually also additional information about material and surface properties.

For example, the conversion of screen coordinates into device coordinates, texturing, clipping and anti-aliasing are performed in the 3D rendering graphics pipeline. The pixelated image, which represents a two-dimensional projection of the scene, and which is stored in the frame buffer of a graphics adapter, contains the pixel values for the controllable pixels of a monitor screen, for example an LC display.

As regards the computer-generated video holograms, this invention relates to a holographic graphics pipeline. Complex hologram values are generated in this pipeline in the form of pixel values for a light modulator means SLM. As regards the generation of holographic data, the invention relates to a transformation of regions of a scene, said transformation describing the propagation of light waves. During the holographic reconstruction of the three-dimensional objects or scenes, a light wave front is generated through interference and superimposition of coherent light waves.

In contrast to classic holograms, which are stored photographically or in another suitable way in the form of interference patterns, CGVH exist as the result of a computation of hologram data from sequences of a scene and are stored in electronic means. Modulated light which is capable of generating interference propagates in the space in front of the eyes of an observer in the form of a light wave front which is controllable as regards their amplitude and phase values, said light wave front thereby reconstructing a scene. Controlling a light modulator means with the hologram values of the video holograms causes the wave field emitted from the display screen, the individual pixels of which having been modulated accordingly, to reconstruct the desired scene by creating interferences in the reconstruction space.

The holographic display device preferred for implementing the present invention comprises at least one screen means. The screen means is either the light modulator itself where the hologram of a scene is encoded or an optical element—such as a lens or a mirror—on to which a hologram or wave front of a scene encoded on the light modulator is projected. The definition of the screen means and the corresponding principles for the reconstruction of the scene in the visibility region are described in other documents filed by the applicant. In documents WO 2004/044659 and WO 2006/027228, the screen means is the light modulator itself. In document WO 2006/119760, projection device and method for holographic reconstruction of scenes, the screen means is an optical element on to which a hologram which is encoded on the light modulator is projected. In document DE 10 2006 004 300, projection device for the holographic reconstruction of scenes, the screen means is an optical element on to which a wave front of the scene encoded on the light modulator is projected. Document WO 2006/066919 filed by the applicant describes a method for computing video holograms.

In this document, the term ‘light modulator means’ or ‘SLM’ denotes a device for controlling intensity, colour and/or phase of light by way of switching, gating or modulating light beams emitted by one or several independent light sources. A holographic display device typically comprises a matrix of controllable pixels, which reconstruct object points by modifying the amplitude and/or phase of light which passes through the display panel. A light modulator means comprises such a matrix. The light modulator means may for example be an acousto-optic modulator AOM or a continuous-type modulator. One embodiment for the reconstruction of the holograms by way of amplitude modulation can take advantage of a liquid crystal display (LCD). The present invention also relates to further controllable devices which are used to modulate sufficiently coherent light into a light wave front or into a light wave contour.

In this document, the term ‘pixel’ denotes a controllable hologram pixel in the SLM; a pixel is individually addressed and controlled by a discrete value of a hologram point. Each pixel represents a hologram point of the video hologram. In an LCD, the term ‘pixel’ is therefore used for the individually addressable image points of the display screen. In a DLP, the term ‘pixel’ is used for an individual micro-mirror or a small group of micro-mirrors. In a continuous SLM, a ‘pixel’ is the transitional region on the SLM which represents a complex hologram point. The term ‘pixel’ thus generally denotes the smallest unit which is able to represent or to display a complex hologram point.

### TECHNICAL BACKGROUND OF THE INVENTION AND PRIOR ART

An ‘observer window’ is a limited virtual region through which the observer can watch the entire reconstruction of the scene at sufficient visibility. The observer window is situated on or near the observer eyes. The observer window can be displaced in the x, y and z directions. Within the observer window, the wave fields interfere such that the reconstructed object becomes visible for the observer. The windows are situated near the observer eyes and can be tracked to the actual observer position with the help of known position detection and tracking systems. They can therefore preferably be limited to a size which is only little larger than the size of the eye pupils. It is possible to use two observer windows, one for each eye. Generally, more complex arrangements of observer windows are possible as well. It is further possible to encode video holograms such that individual objects or the entire scene seemingly lie behind the light modulator for the observer.

The term ‘transformation’ shall be construed such as to include any mathematical or computational technique which is identical to or which approximates a transformation. Transformations in a mathematical sense are merely approximations of physical processes, which are described more precisely by the Maxwellian wave equations. Transformations such as Fresnel transformations or the special group of transformations which are known as Fourier transformations, describe second-order approximations. Transformations are usually represented by algebraic and non-differential equations and can therefore be handled efficiently and at high performance using known computing means. Moreover, they can be modelled precisely as optical systems.

Document WO 2006/066919 filed by the applicant describes a method for computing computer-generated video holograms. According to that method, objects with complex amplitude values of a scene are assigned to matrix dots of parallel virtual section layers such that for each section layer an individual object data set is defined with discrete amplitude values in matrix dots, and a holographic code for the light modulator means of a holographic display device is computed from the image data sets.

According to this invention, the solution of the object takes advantage of the general idea that the following steps are carried out aided by a computer:
A diffraction image is computed in the form of a separate two-dimensional distribution of wave fields for an observer plane, which is situated at a finite distance and parallel to the section layers, from each object data set of each tomographic scene section, where the wave fields of all sections are computed for at least one common virtual observer window which is situated in the observer plane near the eyes of an observer, the area of said observer window being reduced compared with the video hologram;
The computed distributions of all section layers are added to define an aggregated wave field for the observer window in a data set which is referenced in relation to the observer plane;
The reference data set is transformed into a hologram plane, which is situated at a finite distance and parallel to the reference plane, so as to create a hologram data set for an aggregated computer-generated hologram of the scene, where the light modulator means is situated in the hologram plane, and where the scene is reconstructed in the space in front of the eyes of the observer with the help of said light modulator means after encoding.

The above-mentioned methods and holographic display devices are substantially based on the idea preferably not to reconstruct the object of the scene itself, but to reconstruct in one or multiple observer windows the wave front which would be emitted by the object. The observer can watch the scene through the virtual observer windows. The virtual observer windows cover the pupils of the observer eyes and can be tracked according to the actual observer position with the help of known position detection and tracking systems. A virtual, frustum-shaped reconstruction space stretches between the light modulator means of the holographic display device and the observer windows, where the light modulator means represents the base and the observer window the top of the frustum. If the observer windows are very small, the frustum can be approximated as a pyramid. The observer looks through the virtual observer windows towards the holographic display device and receives in the observer window the wave front which represents the scene.

It is the object of the invention to provide a method for real-time generation of video holograms from image data with depth information. It is a further object of the invention to extend the 3D rendering graphics pipeline in a switchable manner such that, optionally, pixel values for the controllable pixels of a monitor can be generated with the help of the 3D rendering graphics pipeline on the one hand, and that complex hologram values for the pixels of a light modulator means of a holographic display device can be generated with the help of the holographic graphics pipeline on the other in order to reconstruct a scene.

Further, graphics processors and graphics sub-systems which are commercially available today, e.g. as used in graphics cards and games consoles, shall be used. Established industrial standards as regards hardware, software and programme interfaces shall be used without thereby restricting generality.

### SUMMARY OF THE INVENTION

The general idea of the inventive method will be explained below, without detailing possible optimisations. The method is based on image data with depth information. This information is available for example as a description in the form of vertices, normal vectors and matrices. The image data usually contain additional information about material and surface properties etc.

In real-time rendering, a 3D rendering pipeline or graphics pipeline describes the way from the vectorial, mathematical description of a scene to pixelated image data in a frame buffer in order to be displayed on a monitor. For example, the conversion of screen coordinates into device coordinates, texturing, clipping and anti-aliasing are performed in the pipeline. The pixelated image, which represents a two-dimensional projection of the scene, and which is stored in the frame buffer of a graphics adapter, contains the pixel values for the controllable pixels of a monitor screen, for example an LC display. The 3D pipeline is characterised in that individual primitives, such as points and triangles, for example, can be processed in parallel. While for example one triangle is converted from the model coordinate system to the eye coordinate system, another one is already being pixelated, i.e. shaded.

In order to achieve a holographic representation, the scene is reconstructed by way of phase- and/or amplitude-modulation of light which is capable of generating interference, and subsequent superimposition of interference patterns. This 3D rendering graphics pipeline is also used in a first process step for generating the video holograms from image data with depth information. Then, the generation of holographic data is based on a transformation of the scene, where the transformation describes the propagation of the light waves. After a back-transformation, the encoding process is carried out, where complex hologram values are transformed into pixel values for the one or multiple light modulator means of the holographic display device.

The invention is based on the idea to extend an existing and available 3D rendering graphics pipeline for the representation of 2D/3D scenes on displays in a switchable manner such that both a 2D/3D representation and the generation of video holograms is ensured. This means that the pixel values for the controllable pixels of a monitor are generated with the help of the 3D rendering graphics pipeline. Finally, a light modulator is simultaneously or alternatively controlled with the encoded hologram values in a switchable manner through a holographic graphics pipeline.

The holographic graphics pipeline comprises as a first process step a slicing step, which means a separation of section layers of the canonical image space. The scene is thereby sliced into section layers by two parallel section planes each, and the scene section data is separated. The section planes preferably lie at right angles to the viewing direction of an observer, and the distance between the section planes is chosen to be small enough to ensure both a sufficient precision of the calculation but also a good processing performance. Ideally, the distance should be very small, so that only the depth information which is at a constant distance to the observer must be considered during the calculations. If the distance between the planes is greater, the depth information shall be chosen such that for example an average distance between the two planes is defined and assigned to a certain layer.

A subsequent viewport operation converts canonical image coordinates into pixel coordinates of the output window. Then, the data are pixelated and additional optimising pixel operations are preferably carried out, for example blending operations.

In the subsequent process step, the scene section data are transformed. Generally, a transformation describes the propagation of the light waves to the virtual observer window. The most simple transformations are Fourier transformations and Fresnel transformations. The Fourier transformation is preferably used in the far field, where due to the large distance to the observer the light waves can be interpreted as a plane wave front. In contrast to other transformations, the Fourier transformation exhibits the advantage that the transformation can be modelled with the help of optical elements—and vice versa. In the near field of a spherical wave, a Fresnel transformation is preferably used.

The transformations are now repeated, thereby successively displacing the section planes in the viewing direction, until the entire scene is transformed. The transformed data of the scene section data are successively added so as to form an aggregated reference data set. After transformation of the entire scene, this reference data set represents the sum of the transformations of the individual scene section data.

In a subsequent process step, a back-transformation is performed, where the reference data are transformed into a hologram plane which coincides with the position of a light modulator means, and which is situated at a final distance and parallel to the reference plane, so as to generate hologram data for the video hologram. In a last process step, the encoding process is performed, where after a normalisation the transformation into pixel values is performed. If the Burckhardt encoding method is used, the complex hologram value is represented by three values which are normalised in a range between 0 and 1, where the value represented by 1 forms the maximum achievable component value.

The encoded pixel values are now transferred in a frame buffer to the light modulator means, where light which is capable of generating interference is phase- and/or amplitude-modulated, and a scene is reconstructed with the help of interference patterns generated by superimposed light waves.

If colour image contents are to be generated, the method is applied analogously for each colour component. In order to represent the colour video hologram by way of space division multiplexing, each pixel may be composed of sub-pixels for each of the three primary colours for the representation or display of coloured hologram points. Depending on the kind of video hologram encoding, further sub-pixels may be used to represent the primary colours of each coloured hologram point. Another preferred method is that of time division multiplexing.

According to a further embodiment of the invention, the 3D rendering graphics pipeline and the holographic graphics pipeline are parallelised when processing a sequence of scenes. For the storage of resulting data of a sequence of scenes, multiple memory sections are assigned to the first group of steps of the 3D rendering graphics pipeline so as to form visible scene buffers. Multiple successive scenes are preferably assigned to a visible scene buffer each for the storage of resulting data. One or multiple holographic graphics pipelines now generate hologram values on the basis of those data. Each visible scene buffer is preferably assigned with a holographic graphics pipeline.

Further, a control unit is provided which optimises the timing of the first group of steps of the 3D rendering graphics pipeline, the visible scene buffers and the holographic graphics pipelines. The control unit manages the optimal efficiency of the existing resources and ensures optimal scheduling of the individual steps of processing individual scenes. The control unit further optimises the discretisation of the scene, i.e. the number and distance of the section layers. In the near field, a fine discretisation is preferred, whereas in the far field a more coarse discretisation will usually suffice.

The method according to this invention ensures a real-time generation of complex hologram values. However, thanks to the switchable extension of the 3D rendering graphics pipeline according to the invention, a conventional monitor can also be used. This invention permits the optional and even the simultaneous use of a conventional monitor and a holographic display device, while the compatibility with existing industry standards and conventions is ensured. This advantage of the invention will guarantee a wide technical and economic acceptance of the new holographic display technology.

### PREFERRED EMBODIMENTS OF THE INVENTION

Further aspects and details of the invention will be explained below with the help of embodiments and accompanying drawings. In particular, a parallelism of the process steps as suggested in the further embodiment of the invention will be detailed.

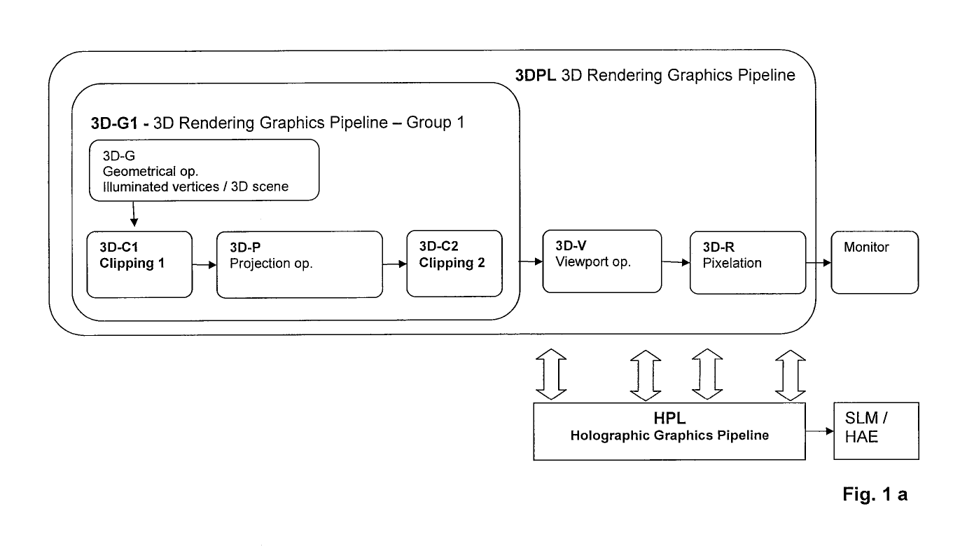

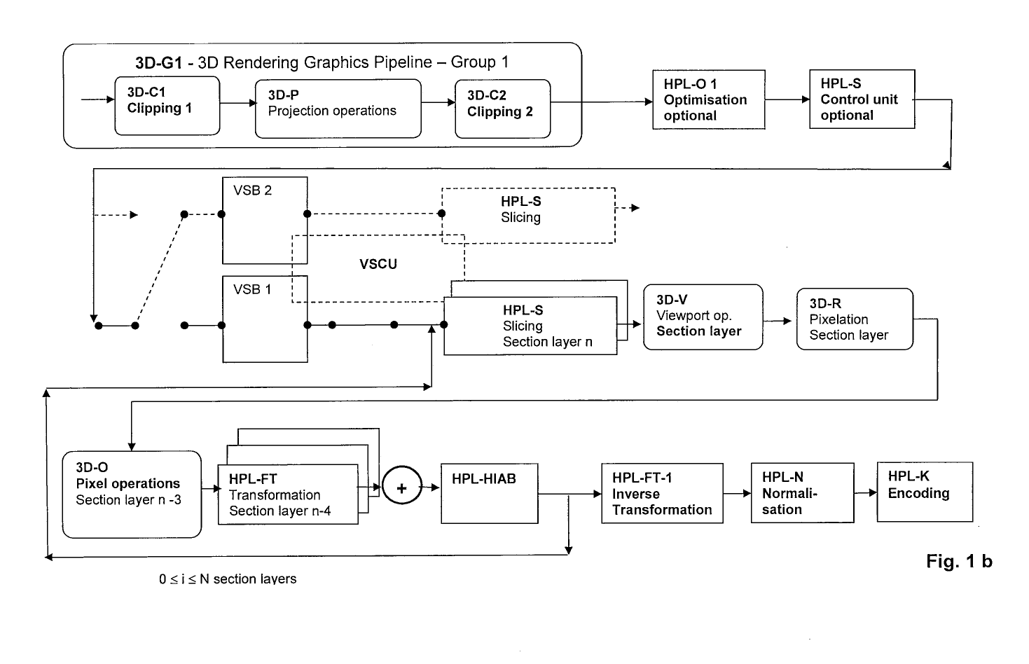

FIG. 1a shows a flowchart of the method which illustrates the process steps of the 3D rendering graphics pipeline (3DPL) and of the holographic graphics pipeline (HPL) implemented therein. The steps of the 3D rendering graphics pipeline are shown in boxes with rounded corners (3DG), and those of the holographic graphics pipeline are shown in rectangular boxes.

The 3D rendering graphics pipeline comprises a first and a second group of steps. The first group (3D-G1) comprises geometrical operations (3D-G) and clipping operations (3D-C1,2). Geometrical operations (3D-G) comprise mainly modelling operations, global operations, viewing operations and projection operations (3D-P).

The projection operations here comprise operations to convert the reconstruction space, i.e. the frustum, into a normalised canonical object space. This object space has the form of a cube or cuboid, depending on the kind of graphics system used. This space is then normalised. This operation has the effect that the vertices are converted from a perspective space into the normalised space of the parallel transformation.

Clipping operations describe how the geometrical forms are cut off by the edges of the visibility pyramid and by further, user-defined section planes. Illumination operations are executed to take into account ambient light, diffuse light, specular light, emissive light, so that by way of arithmetic operations with the material properties of the surfaces a new colour value is calculated which depends on the positions of the observer and of the light sources, thus effecting a shading of those surfaces.

FIG. 1b shows further details of the method. The results of the first group of steps (3D-G1) are stored in a visible scene buffer (VSB). The visible scene buffer (VSB), which physically forms a memory section, contains information about the geometry, i.e. vertices, colours, normals and texture coordinates. The visible scene buffer (VSB) contains the geometrical forms already in a condition where all vertex operations have been completed, i.e. one or multiple modelling operations have already been applied to the vertices in accordance with their position within the visibility hierarchy. Based on the data in the visible scene buffer (VSB), complex hologram values are now generated in a holographic graphics pipeline (HPL) as pixel values for a light modulator (SLM). The holographic graphics pipeline (HPL) comprises as a first process step a slicing step (HPL-S), which means a separation of section layers of the canonical image space.

A subsequent viewport operation (3D-V) converts canonical image coordinates into pixel coordinates of the output window. Then, the data are pixelated (3D-R) and additional optimising pixel operations (3D-O) are preferably carried out, for example blending operations.

In the subsequent process step, the scene section data are transformed (HPL-FT) into the virtual observer window. These process steps are repeated until the entire scene is transformed. The transformed data of the scene section data are successively added so as to form an aggregated reference data set, also known as holographic accumulation image buffer (HPL-HIAB). After transformation of the entire scene, this reference data set (HPL-HIAB) represents the sum of the transformations of the individual scene section data.

In a subsequent process step, the data contained in the holographic accumulation image buffer (HPL-HIAB) are back-transformed (HPL-FT-1). In a last process step, the encoding process (HPL-K) is performed, where after a normalisation (HPL-N) the transformation into pixel values is performed. If it is not desired to generate hologram data, the pixel values for the controllable pixels of a conventional monitor, such as an LCD panel, can be generated with the steps of the 3D rendering graphics pipeline, i.e. geometrical operations (3D-G), clipping operations (3D-C1,2), illumination operations, viewport operations (3D-V), pixelation (3D-R) and additional optimising pixel operations (3D-O-1).

Further preferred embodiments of this invention relate to the extended parallelism, variable interlinking and optimised utilisation of resources with control strategies which are also variable if necessary.

For this, at least one control unit (HPL-S) is provided which optimises the timing of k groups of steps of the 3D rendering graphics pipeline, L visible scene buffers and m holographic graphics pipelines. The process steps of the first embodiment are arranged linearly and sequentially with k=L=m=1. The control unit manages the optimal efficiency of the existing resources and ensures optimal scheduling of the individual steps of processing individual scenes. The ratio of the parameters k, L, m defines the general degree of parallelism, which may still be varied by the control unit for an individual scene, in accordance with certain control strategies.

The control unit further optimises the discretisation of the scene, i.e. the number and distance of the section layers. In the near field, a fine discretisation is preferred, whereas in the far field a more coarse discretisation will usually suffice. A single visible scene buffer (VSB) can also be assigned with multiple holographic graphics pipelines (HPL), for subsections of VSBs to be processed in parallel. A local control unit, also referred to as a visible scene control unit (VSCU), controls and monitors this local parallelism. If necessary, it also controls and monitors the exchange of sub-results of the parallel processes. In a similar way, it is possible that multiple visible scene buffers (VSB) are assigned to one holographic graphics pipeline (HPL). Analogously, the steps of transforming (HPL-FT) and/or back-transforming (HPL-FT- 1) can be parallelised in a holographic graphics pipeline. The control unit controls the overall process and ensures that the scene section data are processed in the correct order of steps. Further instances of parallelismare possible in the course of the general principle of this invention, in order to ensure the real-time generation of hologram data. This invention also relates to a device which comprises means for implementing the aforementioned process steps.

1. Method for real-time rendering and generation of computer-generated video holograms from image data with depth information, where in a first mode a 3D rendering graphics pipeline (3DPL) describes the conversion of a scene into pixelated image data in the form of a two-dimensional projection of the scene and which generates pixel values for the controllable pixels of a monitor, characterised in that the pipeline is switchably extended such that in a second mode in at least one holographic graphics pipeline (HPL) complex hologram values are generated and a light modulator means (SLM) of a holographic display device (HAE) is encoded with these pixel values, whereby simultaneously or alternatively to the usual graphic representation an incident wave field is modulated by way of controlling the light modulator means (SLM) such that the desired scene is reconstructed through interference in space.

2. Method according to claim 1 where the 3D rendering graphics pipeline includes a first group of steps comprising coordinate operations, illumination calculations and clipping, in order to generate input data for the subsequent holographic graphics pipeline.

3. Method according to claim 2 where for the storage of resulting data of a sequence of scenes additional memory sections are assigned to the first group of steps of the 3D rendering graphics pipeline (3DPL) so as to form visible scene buffers.

4. Method according to claim 3 where resulting data for multiple successive scenes are generated for an assigned visible scene buffer (VSB) by the first group of steps of the 3D rendering graphics pipeline (3DPL), and where complex hologram values are generated by one or multiple holographic graphics pipelines (HPL) based on these data.

5. Method according to claim 4 where each visible scene buffer (VSB) is assigned with one scene of the video sequence.

6. Method according to claim 5 with a control unit which sequentially controls the first group of steps of the 3D rendering graphics pipeline (3DPL), the visible scene buffers (VSB) and the holographic graphics pipelines (HPL).

7. Method according to claim 1 where the position of an observer defines a view of the scene and where the observer is assigned with at least one virtual observer window, which is situated in an observer plane near the observer eyes; and where the holographic graphics pipeline (HPL) for the generation of the pixel values for the light modulator means comprises the following process steps:
Step (1): Separation of the scene data into parallel layers so as to obtain scene section data between two parallel section planes, each of which is situated at right angles to the viewing direction of the observer,
Step 2: Transformation of the scene section data of a layer into the observer window according to the propagation of the light waves emitted by this layer,
Step (3): Repetition of the steps of separation (1) and transformation (2), while successively displacing the section planes in the viewing direction, until the entire scene is transformed, and addition of the results of the individual transformations,
Step (4): Back-transformation, where the aggregated data are transformed from the observer plane into a hologram plane which coincides with the position of a light modulator means, and which is situated at a final distance and parallel to the observer plane, so as to generate hologram data for the video hologram,
Step (5): Encoding, where after a normalisation step the data are converted into pixel values, which are transferred to the light modulator means in order to reconstruct the scene.

8. Method according to claim 7 where a Fourier transformation or a Fresnel transformation is used for transforming the data.

9. Method according to claim 8 where the 3D rendering and transformation processes are only performed for outlines of the scene (3D-S).

10. Method according to claim 9 where for colour representation the method is applied to each primary colour.

11. Device for real-time rendering and generation of computer-generated video holograms from image data with depth information, which implements the method according to claim 1, comprising means which in a first mode comprise a 3D rendering graphics pipeline (3DPL), which describes the conversion of a scene into pixelated image data in the form of a two-dimensional projection of the scene and which generates pixel values for the controllable pixels of a monitor, characterised in that the pipeline is switchably extended such that in a second mode in at least one holographic graphics pipeline (HPL) complex hologram values are generated and a light modulator means (SLM) of a holographic display device (HAE) is encoded with these pixel values, whereby simultaneously or alternatively to the usual graphic representation an incident wave field is modulated by way of controlling the light modulator means (SLM) such that the desired scene is reconstructed through interference in space.

12. Device according to claim 11 where the position of an observer defines a view of the scene and where the observer is assigned with at least one virtual observer window, which is situated in an observer plane near the observer eyes; and where the holographic graphics pipeline comprises:
Means for the separation of the scene data into parallel layers so as to obtain scene section data between two parallel section planes, each of which is situated at right angles to the viewing direction of the observer,
Means for the transformation of the scene section data of a layer into the observer window according to the propagation of the light waves emitted by this layer,
Means for the repetition of the steps of separation (1) and transformation (2), while successively displacing the section planes in the viewing direction, until the entire scene is transformed, and addition of the results of the individual transformations,
Back-transformation means, where the aggregated data are transformed from the observer plane into a hologram plane which coincides with the position of a light modulator means, and which is situated at a final distance and parallel to the observer plane, so as to generate hologram data for the video hologram,
Encoding means, where after a normalisation step the data are converted into pixel values, which are transferred to the light modulator means in order to reconstruct the scene.

13. Device according to claim 11 for the generation of video holograms for a holographic display device (HAE) with a screen means, where the screen means is either the light modulator means (SLM) itself where the hologram of the scene is encoded, or an optical element on to which a hologram or wave front of the scene encoded on the light modulator means is projected.

14. Holographic display device according to claim 13 where the optical element is a lens or mirror.
